(19) United States
(12) Patent Application Publication
(10) Pub. No.: US 2007/0137785 A1
(43) Pub. Date: Jun. 21, 2007

(54) Method for the renovation of branch lines of conduit pipes

(75) Inventor: Christian Noll, Limburgerhof (DE)

Correspondence Address: LERNER GREENBERG STEMER LLP, P O BOX 2480, HOLLYWOOD, FL, 33022-2480, US

(73) Assignee: Brandenburger Patentverwertung GdbR

(21) Appl. No.: 11/640,761

(22) Filed: Dec. 18, 2006

(30) Foreign Application Priority Data
Dec. 17, 2005 (DE) DE 102005060543.5

(51) Int. Cl. B32B 37/00

(52) U.S. Cl. 156/293; 156/94

(57) ABSTRACT

A method provides for the renovation of leaky walls on branch lines of conduit pipes by a fiber tube which can be pressed against the inner wall of the line and is impregnated with a curable resin and which is coated on its inside with a water-soluble film. In this manner the branch line is renovated quickly and inexpensively.

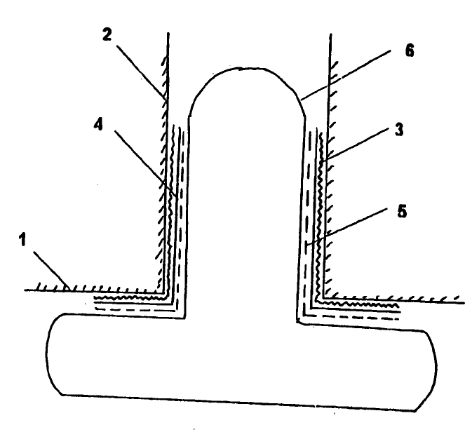

### CROSS-REFERENCE TO RELATED APPLICATION

This application claims the priority, under 35 U.S.C. §119, of German application DE 10 2005 060 543.5, filed Dec. 17, 2005; the prior application is herewith incorporated by reference in its entirety.

### BACKGROUND OF THE INVENTION

### Field of the Invention

The invention relates to a method for the renovation of leaky walls on branch lines of conduit pipes, in particular of domestic connection lines, by a lining part capable of being pressed against the inner wall of the line and contains a fiber tube which is impregnated with a curable synthetic resin and which is provided on its inside with a film.

A particularly elegant method for the renovation of underground sewage conduits is for a flexible fiber tube impregnated with a reaction resin to be introduced into the conduit and inflated there and for the resin thereafter to be cured. International patent disclosure WO 00/73692, corresponding to U.S. Pat. No. 6,679,966, describes a lining tube of this type. It contains a resin-impregnated fiber strip which is provided on the outside and also on the inside with a film tube. The film tubes may be formed from polyamide or polyethylene. Both are water-insoluble polymers.

Where sewage conduits are concerned, leaky places, such as cracks and gaps, often occur on the walls of branch lines from the main conduit which lead to plots of land. On the one hand, the sewage contained in the conduit escapes through these places into the soil, thus causing unpleasant odors, but, on the other hand, ground water may even enter the conduit, with the result that the water quantity to be discharged from the conduit is increased. Published, non-prosecuted German patent application DE 39 29 558 A therefore proposes to introduce into the connecting region between the main conduit and the branch line a lining part capable of being pressed against the inside of the branch line and formed of a fibrous web impregnated with synthetic resin. The fibrous web may contain a plurality of layers and be provided with an inner film or with a liquid-impermeable layer.

Published, European patent application EP 740 102 A likewise describes a method for the renovation of leaky walls of branch lines. There, the lining part is provided on the outside with an epoxy resin which, as an adhesive, is to bring about a good connection to the inner wall of the branch line.

In practice, a lining part for the renovation of branch lines is prepared at the present time as now described. A film formed of a water-insoluble polymer, for example of polyamide, polyethylene or composite films, is applied to a hat-shaped metal tool. A resin-impregnated fibrous structure preconsolidatable by thickening is applied to this, and, as a result, the lining part in the shape of a top hat open at the top (“hat profile”) having the inner film is formed. The inner film is drawn out of the hat profile, an inflatable rubber carrier in the form of an upturned T is introduced from below into the hat profile. The hat profile can then be introduced into the branch line and be cured.

The inner film is necessary because the fiber tube impregnated with the curable resin would otherwise adhere to the metal tool and would be difficult to draw off from the latter. The water-insoluble inner film has to be drawn off again before further processing, since it would otherwise come loose due to the water flow during subsequent operation, and this may lead to blockages in the conduit pipe.

When the inner film is being drawn out, there is the risk, then, that parts, for example fibers, are torn out of the resin-impregnated fibrous structure, particularly when the resin has previously been greatly thickened. During subsequent operation, damage and leaks may occur at the weakened points on the lining part. Furthermore, at the edge regions of the hat profile, some adhesive may run out and bond with the rubber carrier when the inner film has been drawn out.

### SUMMARY OF THE INVENTION

It is accordingly an object of the invention to provide a method for the renovation of branch lines of conduit pipes and also a lining part which overcome the above-mentioned disadvantages of the prior art devices and methods and devices of this general type.

With the foregoing and other objects in view there is provided, in accordance with the invention, a method for renovating leaky walls on branch lines of conduit pipes. The method includes providing a lining part capable of being pressed against an inner wall of a branch line and has a form of a top hat open at a top defining a hat profile and formed of a fibrous structure impregnated with a curable resin. The hat profile is provided with an inner film, the inner film being formed of a water-soluble polymer. An expandable rubber carrier in a form of an upturned T is introduced into the hat profile. The hat profile is introduced through the conduit pipe into the branch line. The rubber carrier is expanded for fitting the hat profile snugly against the inner wall of the branch line. The curable resin is then cured and the rubber carrier is relieved of pressure and drawn out.

The object is achieved, according to the invention, in that the inner film used is a water-soluble inner film.

The subject of the invention is, therefore, a method for the renovation of leaky walls on branch lines of conduit pipes.

In a preferred embodiment of the invention, the lining part is produced in the form of a hat profile, in that a water-soluble film is laid onto a hat-shaped metal tool, and a preconsolidatable resin-impregnated fibrous structure is applied to this. This may take place either in that resin-impregnated fiber strips formed of a glass fiber web or of a polyester needle felt are laid in place and the strips connected to one another by being pressed down or in that fiber-containing resin is sprayed on. The curable resin is preferably a polyester or vinyl ester resin which is curable by high-energy beams, in particular by UV light, and which for preconsolidation contains a thickening agent, for example based on magnesium oxide.

Thereafter, an expandable, in particular inflatable rubber carrier, for example a rubber bladder formed of transparent silicone rubber, which is in the form of an upturned “T” and preferably projects at the top from the hat profile, is introduced preferably from below into the hat profile.

Subsequently, the hat profile, including the brim, is coated on the outside completely or partially with an adhesive. This may be, for example, an epoxy resin or a polyurethane resin, preferably a two-component resin formed of a polyether polyol or of a polyether/polyester polyol or of a diisocyanate hardener. The adhesive is applied to the hat profile either by being painted on or by being applied with a trowel. The layer thickness may in this case be between 1 and 3 mm. The hat profile should be introduced into the conduit within a half to one hour, since premature curing otherwise commences.

According to a further idea on which the invention is based, the lining part may be prefabricated at the factory.

In another embodiment of the invention, the lining part is manufactured on site, that is to say on the construction site. In this case, first, a brim is attached, for example by stitching, at the lower edge to a tubular fibrous structure formed of, for example, of a needle felt. The water-soluble inner film is introduced into the hat profile, and the hat profile is impregnated with a curable resin. This is, in this case, an epoxy resin which does not need to be preconsolidated. The application of a separate adhesive may be dispensed with here, since the epoxy resin acts at the same time as such. Finally, the inflatable rubber carrier is introduced into the hat profile from below.

In both embodiments, the hat profile is introduced into the conduit by known methods and is laid against the inner wall of the branch line by remote control by a conduit robot. This purpose may be served, for example, by a mobile disk, such as is described in published, European patent application EP 740 102 A, or a shield carriage with an upwardly curved mount on which the hat profile sits. This is stretchable and elastic, as long as the resin-impregnated fibrous structure, although preconsolidated, is not yet cured, so that, when being introduced into the conduit, it can be flipped over. As soon as it has assumed its final position, the rubber carrier is inflated, preferably by the action of air pressure of 0.5 to 0.8 bar. The hat profile thereby fits snugly against the inner wall of the branch line. Then, in the case of the first embodiment, a radiation source, preferably a slide, on which a plurality of UV lamps are mounted, is drawn through the conduit. As soon as the slide has reached the entry point to the branch line, the lamps are switched on and the curing of the polyester or vinyl ester resin commences, this being terminated after a few minutes. At the same time, the reaction of the polyol with the hardener begins, this being largely terminated after about 10 to 20 hours at room temperature.

In the other embodiment, in the case of a cold-curing epoxy resin, the cold curing takes place in the course of a few hours or hot curing is carried out, for example, by IR radiation. The adhesive brings about a better connection between the lining part and the inner wall of the branch line. After curing has ended, the rubber carrier is relieved of pressure and can be drawn out.

According to the invention, the inner film formed of a water-soluble polymer, preferably of a polyvinyl alcohol, which, if appropriate, may be partially saponified up to 20%, for example with acetic acid. The film may have a thickness of between 50 and 200 μm, in particular of between 100 and 150 μm. In principle, other water-soluble polymers, for example based on cellulose ethers, gelatins, polyacrylates, polyvinylpyrrolidone or polyvinyl ethers, may also be used, in so far as they can be processed into films.

One advantage of the method according to the invention is that the inner film tube does not have to be drawn out. The water-soluble polymer dissolves as soon as water flows through the conduit and the branch line.

Other features which are considered as characteristic for the invention are set forth in the appended claims.

Although the invention is illustrated and described herein as embodied in a method for the renovation of branch lines of conduit pipes, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing a diagrammatic, sectional view of a layer build up of a lining part according to the invention after introduction into the branch line and the inflation of the rubber carrier.

### DESCRIPTION OF THE PREFERRED EMBODIMENTS

Referring now to the single FIGURE of the drawing in detail, there is shown a conduit wall 1, a branch line 2, an adhesive 3, a hat profile 4, an inner film 5 and a rubber carrier 6.

In both embodiments, the renovation of the branch line 2 may be carried out directly after the renovation of the main conduit pipe 1. For this purpose, the conduit pipe 1 is lined in a known way with a resin-impregnated fiber tube and the resin is cured. The cured lining part is then cut open by a robot at the entry point to the branch line and the branch line is renovated according to the present invention.

I claim:

1. A method for renovating leaky walls on branch lines of conduit pipes, which comprises the steps of:
providing a lining part capable of being pressed against an inner wall of a branch line and having a form of a top hat open at a top defining a hat profile and formed of a fibrous structure impregnated with a curable resin;
providing the hat profile with an inner film, the inner film formed of a water-soluble polymer;
introducing an expandable rubber carrier in a form of an upturned T into the hat profile;
introducing the hat profile through the conduit pipe into the branch line;
expanding the rubber carrier for fitting the hat profile snugly against the inner wall of the branch line;
curing the curable resin; and
relieving the rubber carrier of pressure and drawing out the rubber carrier.

2. The method according to claim 1, which further comprises:
laying out a water-soluble film onto a hat-shaped tool;
applying a resin-impregnated fibrous structure to the hat-shaped tool covered by the water-soluble film resulting in the hat profile having the inner film being formed;
preconsolidating the resin by thickening;
introducing the inflatable rubber carrier having the upturned T shaped from below into the hat profile;
applying an adhesive to the hat profile on an outside;
introducing the hat profile through the conduit pipe into the branch line;
inflating the rubber carrier so that the hat profile fits snugly against the inner wall of the branch line;
curing the resin and the adhesive; and
relieving the rubber carrier of pressure and then drawing out the rubber carrier.

3. The method according to claim 2, which further comprises selecting the curable resin from the group consisting of a light-curable polyester and a vinyl ester resin preconsolidatable by thickening.

4. The method according to claim 2, which further comprises selecting the adhesive from the group consisting of polyurethane and epoxy resin.

5. The method according to claim 1, which further comprises:
attaching a brim, all-round, to a tubular fibrous structure at a lower edge and the hat profile being consequently formed;
introducing a water-soluble inner film into the hat profile;
impregnating the hat profile with the curable resin;
introducing the inflatable rubber carrier in a form of the upturned T from below into the hat profile;
introducing the hat profile through the conduit pipe into the branch line;
inflating the rubber carrier for fitting the hat profile snugly against the inner wall of the branch line;
curing the resin; and
relieving the rubber carrier of pressure and then drawing out the rubber carrier.

6. The method according to claim 5, wherein the curable resin is an epoxy resin.

7. The method according to claim 1, wherein the inner film is formed from a polyvinyl alcohol or a partially saponified polyvinyl alcohol.

8. A method for renovating conduit pipes and branch lines emanating from the conduit pipes, which comprises the steps of:
lining a main conduit pipe with a resin-impregnated fiber tube;
curing the resin resulting in a cured fiber tube;
cutting open the cured fiber tube at an entry point to a branch line;
renovating the branch line by the steps of:
providing a lining part capable of being pressed against an inner wall of the branch line and having a form of a top hat open at a top defining a hat profile and formed of a fibrous structure impregnated with a curable resin;
providing the hat profile with an inner film, the inner film formed of a water-soluble polymer;
introducing an expandable rubber carrier in a form of an upturned T into the hat profile;
introducing the hat profile through the conduit pipe into the branch line;
expanding the rubber carrier, so that the hat profile fits snugly against the inner wall of the branch line;
curing the resin; and
relieving the rubber carrier of pressure and drawing out the rubber carrier.

9. A lining part, comprising:
a top hat form having an opening at a top and defining a hat profile, said hat profile formed of a fibrous structure impregnated with a curable resin and having an inner film, said inner film formed of a water-soluble polymer, said hat profile configured for receiving an expandable rubber carrier having an upturned T shaped to be introduced into said fibrous structure, for introducing said hat profile into a branch line of a conduit pipe and, after the introducing, the rubber carrier laying said hat profile snugly against an inner wall of the branch line.
